(19) United States
(12) Patent Application Publication
(10) Pub. No.: US 2002/0194299 A1
(43) Pub. Date: Dec. 19, 2002

(54) Device control system

(75) Inventors: Kouichi Yasaki, Kawasaki (JP); Jun Kawai, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/968,521

(22) Filed: Oct. 2, 2001

(30) Foreign Application Priority Data
Jun. 14, 2001 (JP) 2001-179665

(51) Int. Cl. G09G 5/00

(52) U.S. Cl. 709/217; 345/748; 345/733

(57) ABSTRACT

The object of the present invention is to facilitate the input of address information for storage location of information using a remote control unit or other operating terminal, and to facilitate the control for outputting this information at an output terminal. By including address information acquisition means for acquiring address information for information that can be outputted at an output device; address information list administration means for managing one or more addresses as an address information list; address information display means for displaying address information contained on the address information list; input acceptance means for allowing selection of address information for information to be outputted by the output device from among the address information displayed by the address information display means; and device control means for sending control signals to the output device based on the address information received by input acceptance means.

### BACKGROUND OF THE INVENTION

1. Technical Field

The present invention relates to a device control system that controls output devices that acquire information from a storage location indicated by address information and output this information.

2. Description of Related Art

The spread of computer networks has made it easy to receive network services on a global scale by using the Internet. These network services allow websites to be viewed not only on personal computers (PCs), but also on advanced function televisions capable of connecting to the Internet.

When viewing web sites on the Internet, a user will input the Uniform Resource Locator (URL) that is the address information indicating where a web site is located, thereby acquiring the information corresponding to that URL over the Internet. A PC has such input means as a keyboard or a mouse, and so by using these it is easy to input a URL.

However, it's most common to operate a television in the home using a remote control unit, and it's difficult to input a URL using this kind of remote control unit.

One method of using a remote control unit to input a URL would be, for example, a software keyboard configuration, in which a keyboard is displayed on the screen, and the remote control unit is used to select the keys of the keyboard for input of a URL. With such a configuration, however, the same button on the remote control unit has to be pressed repeatedly, making it a rather involved operation for a user.

Another approach would be to provide a separate input means like a keyboard or mouse, just as with a PC. But providing a keyboard or mouse to be used just for input of URLs will result in higher costs. Moreover, such a configuration lacks in convenience, as, in addition to the remote control unit, a user will have to take out this input means just for the purpose of inputting URL and manage this input means together with the remote control unit.

Furthermore, a user who has both such an Internet-connectable television and a PC would have to manage the URLs of the information to be displayed on a television apart from the URLs of the information to be displayed on the PC; it would be more convenient if a user could use a common set of URLs for both PC and television.

### SUMMARY OF THE INVENTION

It is an object of the present invention to facilitate the input from an operating terminal of address information of an information storage location, and to facilitate control for outputting such information on an output device.

The present invention provides a device control system for acquiring information from a storage location indicated by address information and controlling an output device that is to output the information. The device comprises:

address information acquisition means for acquiring address information corresponding to information that can be outputted by the output device;

address information list administration means for storing one or a plurality of address information needed by a user as an address information list, and for updating the address information list based on address information acquired by the address information acquisition means;

address information display means for displaying the address information included on the address information list;

input acceptance means for allowing selection of address information to be outputted to the output device, the selection to be made from among the address information displayed by the address information display means; and

device control means for sending control signals to the output device based on the address information accepted by the input acceptance means.

Here, the device control system can be configured to further comprise address information storage means for storing address information acquired by the address information acquisition means.

Also, the address information list administration means can be configured based on address information accepted by the input acceptance means, to update the address information list relating to this address information.

The device control system can be configured to further comprise state information acquisition means for acquiring state information for the output device, and wherein:

the device control means generates control signals based on the state information of the output device and sends these signals to the output device.

Further, the device control system can be configured to comprise:

control command acquisition means for acquiring control commands for the output device, and

control command learning means for linking control commands acquired by the control command acquisition means with the input acceptance means and storing the same.

Also, the device control system can be configured to comprise information type determination means for determining the type of information that corresponds to the address information accepted by the input acceptance means, and wherein:

the device control means generates control signals for the output device based upon the results of the determination of the information type determination means.

Further, the address information list administration means manages address information corresponding to a plurality of users, and the address information display means selects from the address information list managed by the address information list administration means an address information list corresponding to a user, and displays the same.

The device control system can be configured to further comprise user identification means for identifying each user corresponding to the address information lists managed by the address information list administration means.

The present invention provides an operating terminal for acquiring information from a storage location indicated by address information, and for sending control signals to the output device that is to output the information. The operation terminal comprises:

address information list administration means for storing one or a plurality of address information required by a user as an address information list;

address information display means for displaying address information included on the address information list;

input acceptance means for allowing the selection of address information for information to be outputted at the output device, the selection to be made from among the address information displayed by the address information display means; and

device control means for sending control signals to the output device based on address information accepted by the input acceptance means.

The operating terminal can be configured to further comprise data transmission and reception means for the transmission and reception of data in a wired or wireless manner with an information processing device having address information acquisition means for acquiring address information corresponding to information capable of being outputted to the output device, and wherein address information acquired by the address information acquisition means of the information processing device is acquired by means of the data transmission and reception means, and the address information list managed by the address information list administration means is updated.

Also, based on address information accepted by the input acceptance means, the address information list administration means acquires from the information processing device address information relating to this address information and updates the address information list.

The operating terminal can be configured to further comprise state information acquisition means for acquiring state information of the output device, and wherein:

the device control means generates control signals based on state information of the output device and sends these to the output device.

The operating terminal can be configured to further comprise:

control command acquisition means for acquiring control commands for the output device, and

control command learning means for linking control commands acquired by the control command acquisition means with the input acceptance means and storing the same.

Also, the operating terminal can be configured to further comprise information type determination means for determining the type of information that corresponds to the address information accepted by the input acceptance means, and wherein:

the device control means generates control signals for the output device based upon the results of the determination of the information type determination means.

Further, the address information list administration means manages address information corresponding to a plurality of users, and the address information display means selects from the address information list managed by the address information list administration means an address information list corresponding to a user, and displays the same.

Also, the operating terminal can be configured to further comprise user identification means for identifying each user corresponding to the address information lists managed by the address information list administration means.

The present invention provides an information processing device for acquiring information from a storage location indicated by address information and to send data to and receive data from an operating terminal that sends control signals to an output device that is to output the information. The device comprises:

address information acquisition means for acquiring address information corresponding to information that can be outputted by the output terminal, and

address information list sending means for sending the address information needed by a user from among the address information acquired by the address information acquisition means in accordance with requests from the operating terminal.

Here, the information processing device can be configured to further comprise communications means capable of connecting with the Internet and address information storage means for storing address information acquired by the address information acquisition means.

Also, the information processing device can be configured to further comprise state information acquisition means for acquiring state information of the output device, and wherein the state information is sent in accordance with requests from the operating terminal.

The information processing device can be configured to further comprise control command acquisition means for acquiring control commands for the output device, and wherein the control commands are sent in accordance with requests from the operating terminal.

Also, the information processing device can be configured, based on the type of information that corresponds to the address information, to preset control commands for the output device and store in the address information storage means, and in accordance with requests from the operating terminal, the address information is sent together with the corresponding control commands.

This information processing device can be configured by a home server interconnected in a wired or wireless manner with the output device. In this case, the address information acquisition means extracts and acquires address information contained in packets sent by the output device to request information.

Also, the information processing device can be configured to further comprise state information acquisition means for acquiring state information for the output device, so that the state information is sent in accordance with requests from the operating terminal.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is an explanatory diagram showing the configuration of a first embodiment of the present invention;

FIG. 2 is an explanatory diagram showing the configuration of a second embodiment;

FIG. 3 is an explanatory diagram showing the configuration of a third embodiment;

FIG. 4 is an explanatory diagram showing the configuration of a fourth embodiment;

FIG. 5 is an explanatory diagram showing the configuration of a fifth embodiment;

FIG. 6 is an explanatory diagram showing the configuration of a sixth embodiment;

FIG. 7 is an explanatory diagram showing the configuration of a seventh embodiment;

FIG. 8 is an explanatory diagram showing the configuration of an eighth embodiment;

FIG. 9 is a flowchart showing the operations of a remote control unit according to the first embodiment;

FIG. 10 is a flowchart showing the operations of an information processing device according to the first embodiment;

FIG. 11 is a flowchart showing the operations of the remote control unit according to the third embodiment;

FIG. 12 is a flowchart showing the operations of the information processing device according to the third embodiment;

FIG. 13 is a flowchart showing the operations of the remote control unit according to the fourth embodiment;

FIG. 14 is a flowchart showing the operations of the home server according to the fourth embodiment;

FIG. 15 is a flowchart showing the operations of the remote control unit according to a variation on the fourth embodiment;

FIG. 16 is a flowchart showing the operations of the home server according to the fifth embodiment;

FIG. 17 is a flowchart showing the operations of the remote control unit according to the seventh embodiment;

FIG. 18 is a flowchart showing the operations of the home server according to the seventh embodiment;

FIG. 19 is a flowchart showing the operations of the remote control unit according to the eighth embodiment; and

FIG. 20 is a flowchart showing the operations of the home server according to the ninth embodiment.

### DETAILED DESCRIPTION OF THE PREFERRED EMBODIMENTS

First Embodiment

Configuration

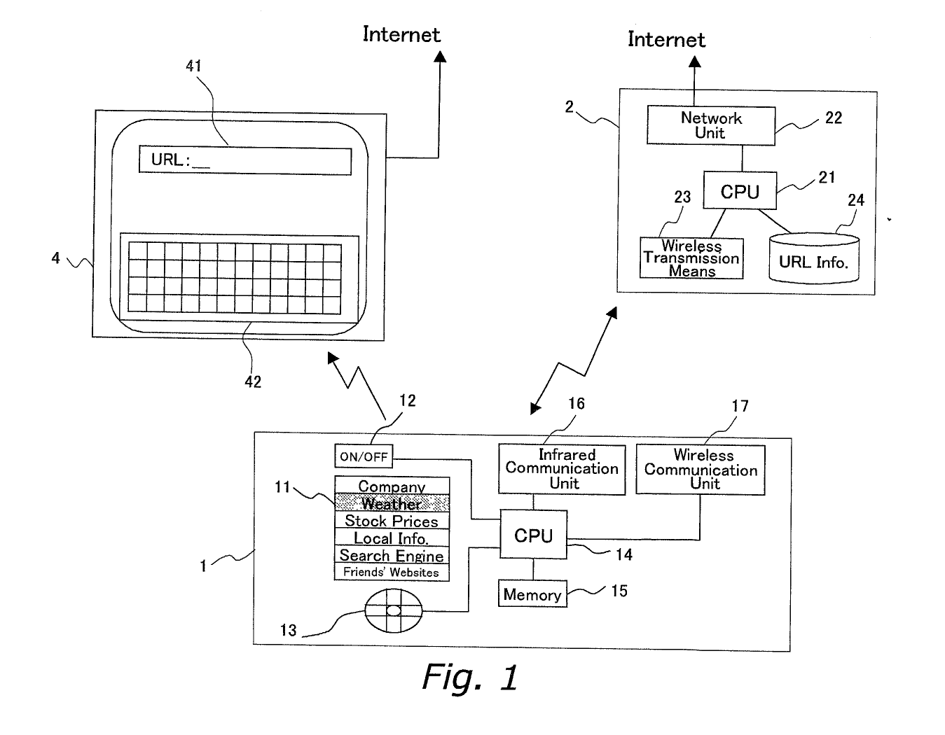

FIG. 1 shows a device control system according to a first embodiment of the present invention.

In this first embodiment we shall consider a control system for an output device 4 that can be remotely operated by a remote control unit 1. Let us suppose a case where the output device is a television that can connect with the Internet through a network or through cable, the remote control unit 1 is used to operate the output device 4, and information acquired over the Internet is displayed on the screen of the output device 4.

The output device 4 displays a URL acceptance screen for accepting address information indicating the storage location for information on the Internet. As can be seen in the example shown in FIG. 1, a URL acceptance screen includes a URL display unit 41 and a software keyboard 42 for accepting an input of URLs.

The remote control unit 1 has a power button 12 for turning the device on or off, an address information display unit 11 for displaying a list of address information, and a selection button for selecting a desired address from among those displayed by the address information display unit 11, and for selecting other operations.

Inside the remote control unit 1 are a CPU 14 comprising a microprocessor or the like, a memory 15 comprising ROM, RAM EEPROM or the like, for storing operational programs and constants as well as URLs and the like, an infrared communications unit 16 that transmits control signals to the output device 4, and a wireless communications unit 17 allowing reception and transmission of data to and from an information processing device 2.

To input a URL using the software keyboard 42, the operation button 13 on the remote control unit 1 is operated to move a cursor on the screen, and the address is inputted as a user uses the cursor to select the proper characters in order.

The address information display unit 11 of the remote control unit 1 displays a list of URLs needed by a user. By manipulating the operation button 13 to select a desired URL from among those displayed at the address information display unit 11, the URL can be transmitted to the output device 4 by the infrared ray transmission unit 16.

A URL inputted through the software keyboard 42 or through the remote control unit 1 is displayed at the URL display unit 41. The output device 4 sends an information request packet to the URL indicated at the URL display unit 41, and displays the information that is transmitted in return on the screen.

The transmission of a URL from the remote control unit 1 to the output device 4 can be accomplished by using infrared ray communication protocols such as IrDA for transmission of standard operating instructions.

The reception and transmission of data between the remote control unit 1 and the information processing device 2 that can connect with the Internet is conducted through the wireless communications unit 17. The information processing device 2 can be, for example, a router, proxy server or other communication device, or it can be a home server that controls a PC or other household device containing this kind of communications device.

Data reception and transmission between the information processing device 2 and the remote control unit 1 can be conducted using wireless communications means using radio waves, such as those specified by Bluetooth, HomeRF, IEEE 802.11b or the like; an infrared communication unit can be used in place of the wireless communications unit 17, and in some cases wired connections using a power-line LAN or the like are conceivable.

As was described above, the information processing device can be a communication device such as a router or proxy server, or it can be a home server that controls a PC or other household device containing this kind of communications device; it contains a CPU 21 that is a microprocessor, a network unit 22 that connects with the Internet, and an address information storage unit 24 that acquires and stores URLS on the Internet and the URLs of web pages related to that URL, and a wireless communications unit 23 that conducts reception and transmission of data with the wireless communications unit 17 of the remote control unit 1. The address information storage unit 3 can be a recording medium such as a hard disk or MO drive.

When the remote control unit 1 has been manipulated and a specific URL has been selected, the information processing device 2 receives this URL and sends to the remote control unit a list of the most recent URLs that are relevant thereto. The most recent list of the URL can be configured so that the corresponding URLs are extracted from the URLs stored in the address information storage unit 24, or it can be configured so that based on the URL information transmitted by the remote control unit 1, the Internet is accessed and the most recent URLs are acquired.

With such a system configuration as described above, a user can obtain a required URL via the information processing device 2, and make selection thereof while confirming the choice using the remote control unit 1. Therefore, the input of the URL for the information to be displayed on the output device 4 is facilitated, and operations are made simple.

Operations of Remote Control Unit

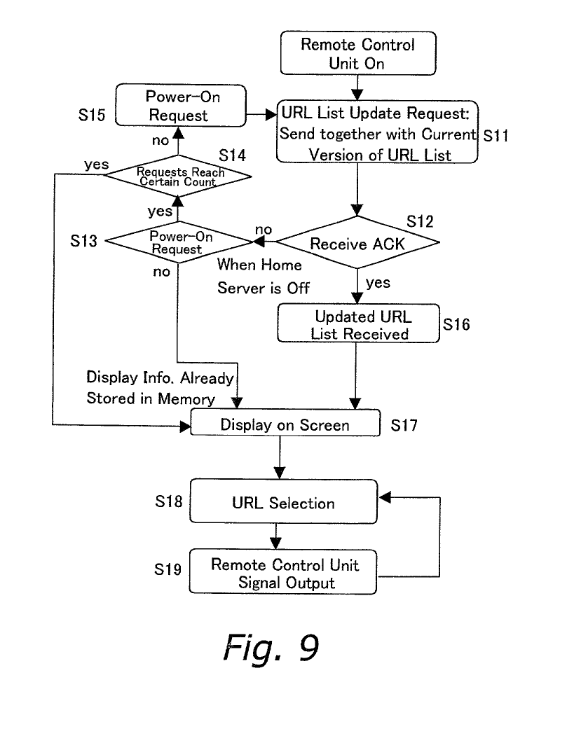

The operations of the remote control unit 1 in the first embodiment will be explained with reference to FIG. 9.

After the remote control unit 1 is turned on, it requests in step S11 update of its URL information list. Specifically, the remote control unit 1 sends its version information of the URL information list to the information processing device 2 using the wireless communications unit 17, and requests that this URL information list be updated.

In step S12, determination is made of whether there has been receipt of a signal from the information processing device 2 acknowledging receipt of the update request. If a signal acknowledging receipt of update request has not been received, control proceeds to step S13. In step S13, determination is made of whether to send a power-on request to the information processing device 2. If determination is made to send a power-on request to the information processing device 2, control proceeds to step S14; if not, control proceeds to step S17. For example, if the information processing device 2 is off, determination is made to send a power-on request to the information processing device 2, and control proceeds to step S14. If for some reason the information processing device 2, even though it is on, is unable to send a signal acknowledging receipt of the update request, determination is made not to send a power-on request to the information processing device 2, and control proceeds to step S17.

In step S14, determination is made of whether power-on requests have reached a certain count. If it is determined that power-on requests have reached a preset count, control proceeds to step S17; if it is determined that power-on requests have not reached a preset count, control proceeds to step S15.

In step S15, a power-on request is sent to the information processing device 2.

In step S16, the remote control unit 1 receives the URL information list sent from the information processing device 2, based upon which it updates its URL information list.

In step S17, the URL information list is displayed on the address information display unit 11. Specifically, if information has been updated based on the URL information list received from the information processing device 2, then the URL information list is displayed in accordance with such updated information. If the URL information list has not been updated, the URL information list is displayed on the address information display unit 11 according to the URL information list already stored in its memory.

In step S18, the remote control unit 1 accepts selection of a URL. Specifically, the selected URL is specified according to how a user operated the operation button 13. In step S19 control signals for the output device 4 based on the selected URL are generated, and this control signals are sent to the output device 4. Thereafter control returns to step S18

Operations at the Information Processing Device

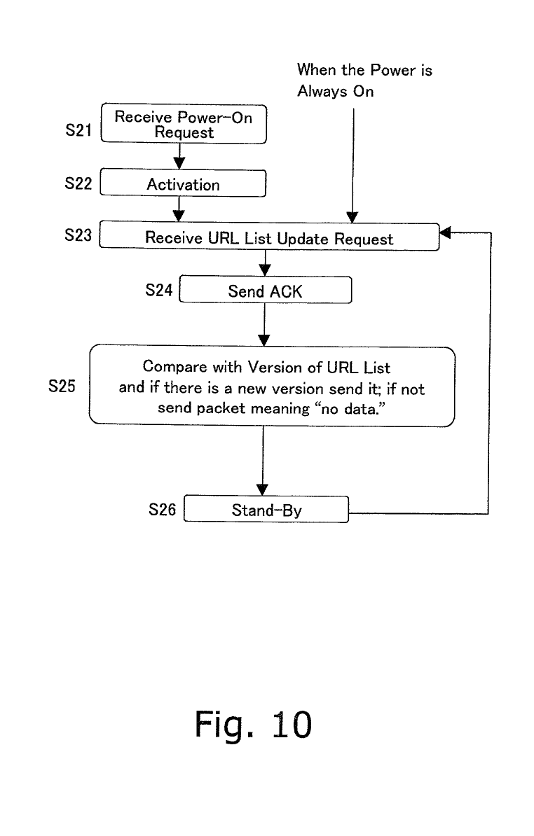

The operations of the information processing device 2 in the first embodiment will be explained with reference made to FIG. 10.

If the information processing device 2 is always on, it is understood that operations commence from step S23. Even if the information processing device 2 is off, it is understood that power is supplied to an interface for receiving power-on requests from the remote control unit 1.

In step S21, when a power-on request signal is received from the remote control unit 1, in step S22 the main power is turned on and the information processing device 2 is activated.

In step S23, a URL information list update request is received from the remote control unit 1. In step S24, a signal is transmitted to the remote control unit 1 acknowledging receipt of the update request signal.

In step S25, a comparison is made between the version of the URL information list received from the remote control unit with the version of the URL information list stored in the address information storage unit 24; if there are new versions of URLS, these are sent to the remote control unit 1, and if there are none, then a packet indicating “no data” is sent.

In step S26, the information processing device 2 stands by for reception of a URL information list update request.

Second Embodiment

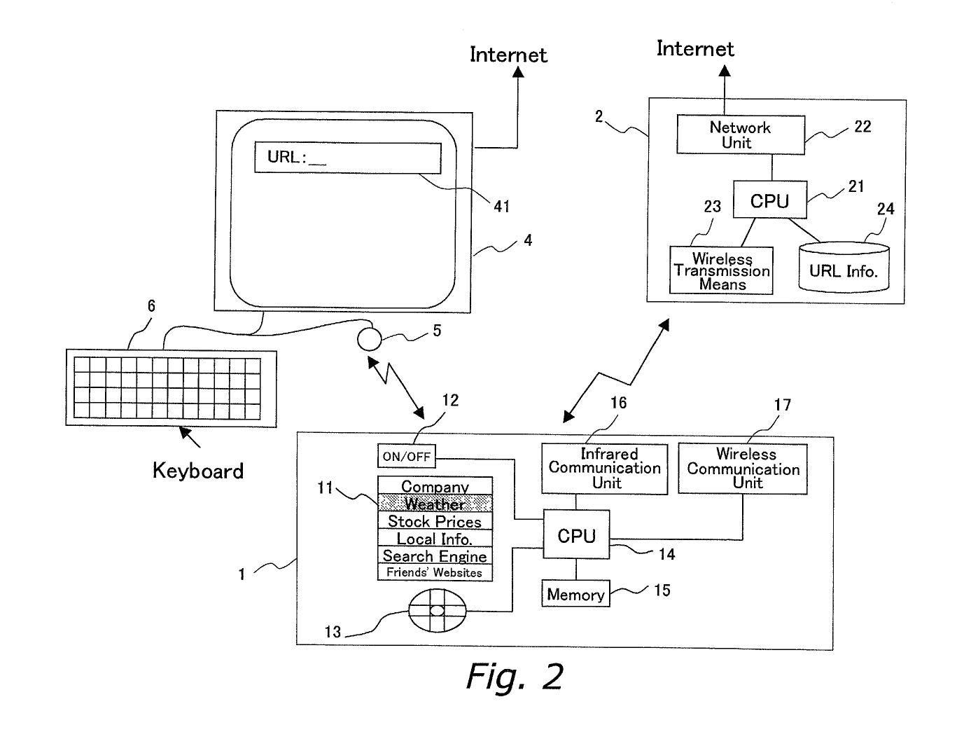

A device control system according to a second embodiment of the present invention will be explained with reference to FIG. 2.

In this second embodiment, we shall consider a case where a personal computer (PC) that can connect with the Internet serves as the output device 4, the output device 4 is operated by the remote control unit 1, and information acquired over the Internet is displayed on the screen of the output device 4.

The output device 4 includes a browser for displaying information on the Internet, and is configured so that when the desired URL is inputted into the URL display unit 41 displayed on a screen, that URL is accessed and information is acquired.

The output device 4 is connected to input means, such as a keyboard 6, for the input of a URL. The output device 4 includes an infrared ray reception unit 5 for receiving data sent from the remote control unit 1, and is configured to display at the URL display unit 41 the received data through a PS/2 interface.

The remote control unit 1 and the information processing device 2 are configured in the same manner as in the first embodiment, and a detailed description will not be repeated here.

In a case such as this, information displayed on the screen of a PC can be controlled from the remote control unit 1, and through the use of the remote control unit 1, which can operate a plurality of devices, the viewing control of information on the Internet can be easily performed. In addition, because URLs can be acquired from a common information source, the administration of URLs for a plurality of devices such as PCs and Internet televisions can be centralized.

In this second embodiment, both the remote control unit 1 and the information processing device 2 operate as they do in the first embodiment, and a detailed explanation thereof will be omitted here.

Third Embodiment

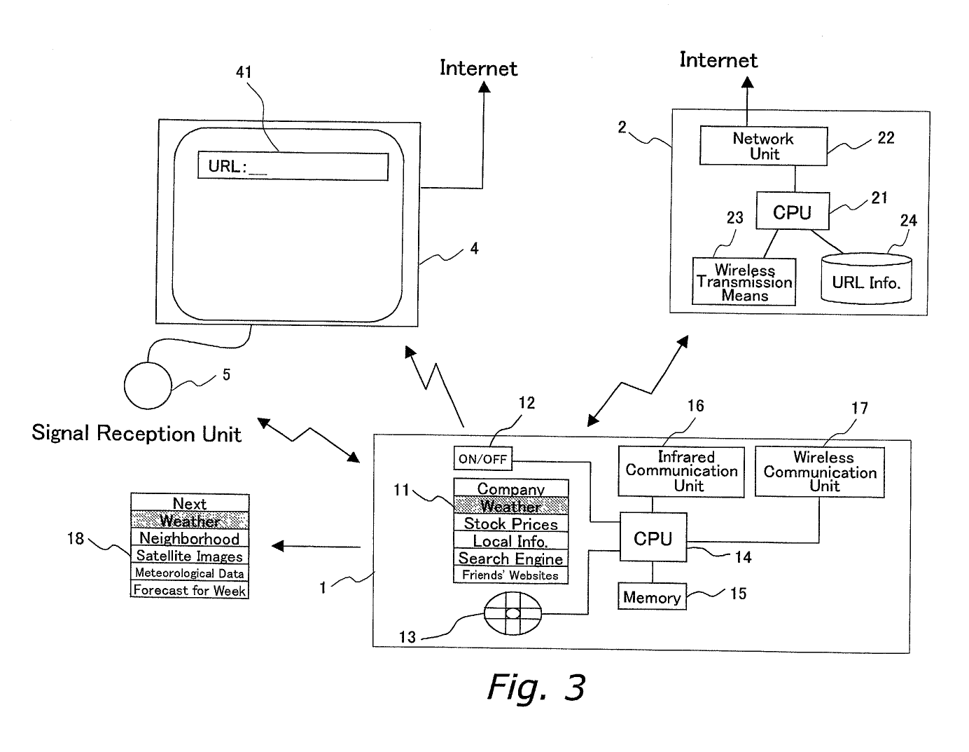

A device control system according to a third embodiment of the present invention will be explained with reference to FIG. 3.

In this third embodiment the output device 4 may be either an Internet TV, as in the first embodiment, or it may be a PC, as in the second embodiment. The remote control unit 1 and the information processing device 2 may be configured as in the preceding embodiments.

The URL that has been selected through the operation of the operation button 13 from among the URLs displayed on the address information display unit 11 of the remote control unit 1 is sent to the information processing device 2. If there are any URLs relating to this URL or URLs included in the page corresponding to this URL, the information processing device 2 sends such URLs to the remote control unit 1 as a sub-list.

The remote control unit 1 displays the sub-list it has received on the address information display unit 11. For example, as shown in FIG. 3, if a user has selected “weather” from the address information display unit 11 of the remote control unit 1, this URL information is sent to the information processing device 2 via the wireless communications unit 17. The information processing device 2 acquires URLs relating to this “weather” URL or the URLs contained in the page corresponding to that URL, and sends this to the remote control unit 1 as a URL list. The URL list can be generated using URLs stored in the address information storage unit 24, or the most recent URLs can be acquired via the network unit 22 from the Internet, and the URL list can be generated from this.

The remote control unit 1 displays the URL list it has received as a sub-list 18 on the address information display unit 11. A user operates the operation button 13 to select a desired URL from this sub-list 18. The system can be configured so that if the information corresponding to a URL has a hierarchical link structure, sub-lists are generated one after another and sent to the remote control unit 1.

With such a system configuration, even if the remote control unit 1 doesn't have lower level link information or the most recent information, it can acquire URLs from the information processing device 2, and generate control signals for the output device 4.

Operations of the Remote Control Unit

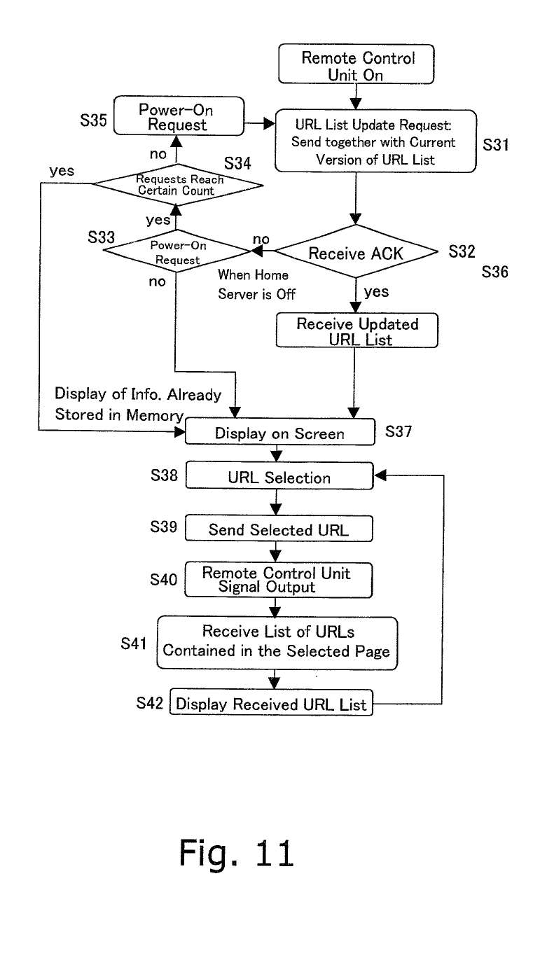

The operations of the remote control unit 1 according to a third embodiment of the present invention will be explained with reference to FIG. 11.

When the remote control unit 1 is turned on, in step S31 it requests update of the URL information list. Specifically, it sends its current version of the URL information list to the information processing device 2 and requests update thereof.

In step S32, determination is made of whether a signal from the information processing device 2 acknowledging receipt of the update request has been received. If a signal acknowledging receipt of the update request has not been received, control proceeds to step S33. In step S33, a determination is made of whether to make a power-on request of the information processing device 2. If determination is made to make a power-on request to the information processing device 2, control proceeds to step S34; if determination is made not to, control proceeds to step S37. For example, if the information processing device 2 is off, then determination is made to make a power-on request, and control proceeds to step S34. But in case the information processing device 2 is on, but for some reason is unable to send a signal acknowledging receipt of the update request, determination is made not to make a power-on request to the information processing device 2, and control proceeds to step S37.

In step S34, determination is made of whether the power-on requests have reached a certain count. If determination is made that the power-on requests have reached a preset count, then control proceeds to step S37; if determination is made that the preset count has not been reached, control proceeds to step S35.

In step S35, a power-on request is sent to the information processing device 2.

In step S36, the URL information list transmitted from the information processing device 2 is received. Based on this received URL information list, the remote control unit 1 updates its version of the URL information list.

In step S37, the URL information list is displayed on the address information display unit 11. Specifically, if the information has been updated based upon the URL information list received from the information processing device 2, the URL information list is displayed in accordance with this updated information. If the URL information list has not been updated, then the remote control unit 1 displays a URL information list in accordance with the URL information list already stored in its memory 15.

In step S38, selection of the URL is accepted. Specifically, the selected URL is specified according to how a user operated the operation button 13. In step S39, the selected URL is sent to the information processing device 2. In step S40, control signals for the output device 4 are generated based on the selected URL, and these control signals are sent to the output device 4.

In step S41, the remote control unit 1 receives from the information processing device 2 a URL information list corresponding to the selected URL. In step S42, the received URL information list is displayed at the address information display unit 11 as the sub-list 18. Thereafter control returns to step S38 to accept further URL selection.

Operations of the Information Processing Device

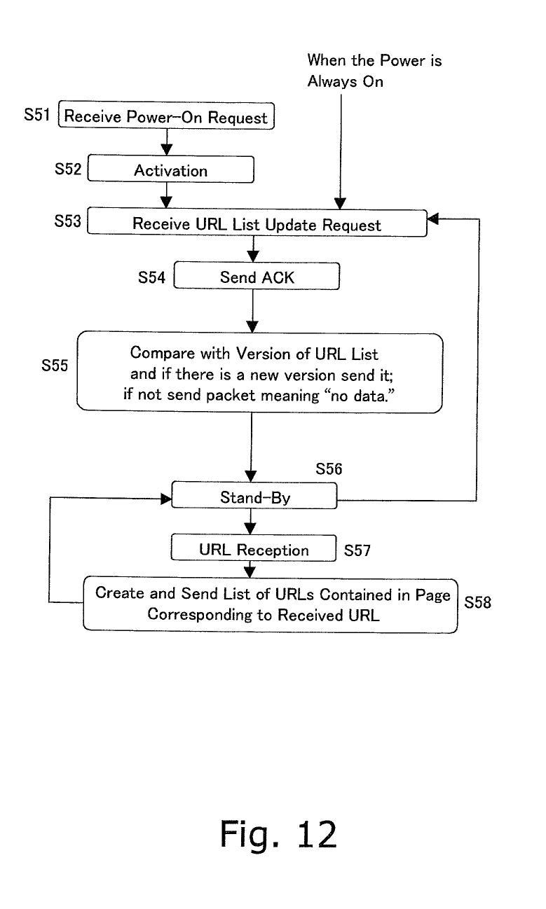

Operations of the information processing device 2 in the third embodiment will be explained with reference made to FIG. 12.

If the information processing device 2 is always on, it is understood that operations commence from step S53. Even if the information processing device 2 is off, it is understood that power is supplied to an interface for receiving power-on requests from the remote control unit 1.

When the information processing device 2 receives a power-on request from the remote control unit 1 in step S51, the main power is turned on in step S52 and the information processing device 2 is activated.

In step S53, an update request signal for the URL information list sent from the remote control unit 1 is received. In step S54, a signal acknowledging receipt of the update request signal is sent.

In step S55, comparison is made between the version of the URL information list received from the remote control unit 1 with the version of the URL information list stored in the address information storage unit 24; if there are new versions of URLs, these are sent to the remote control unit 1; if there are no new versions, a packet indicating “no data” is sent.

In step S56, the information processing device 2 stands by for either receipt of a URL update request, or receipt of a URL included on a URL information list.

In step S57, the information processing device 2 receives the URL selected by a user from among the URLs included on the URL information list. In step S58, it creates a list of URLs included in the information corresponding to the URL it has received and transmits this to the remote control unit 1. For example, when link information is included in a page corresponding to the URL received from the remote control unit 1, the information processing device 2 creates a list of URLs corresponding to this link information and transmits this to the remote control unit 1 as the URL information list. Thereafter control proceeds to step S56.

Fourth Embodiment

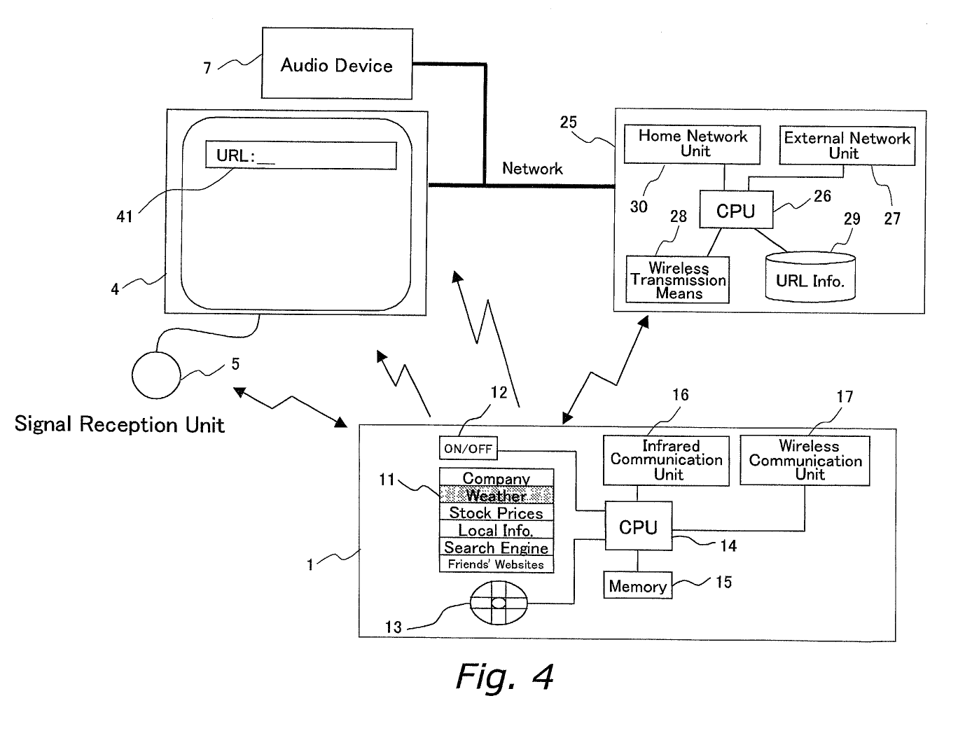

FIG. 4 shows a device control system according to a fourth embodiment of the present invention.

For this fourth embodiment, we shall consider a case where serving as the information processing device is a home server interconnected in a wired or wireless manner with devices inside a residence.

The home server 25 includes a CPU 26 that is a microprocessor for controlling the various units; interconnected with the CPU 26 are an external network unit 27 capable of connecting with the Internet, and a home network unit interconnected with the various devices in a home. A wireless communications unit 28 for the transmission of data to and reception of data from the remote control unit 1 and an address information storage unit 29 for storing acquired URLs are also interconnected with the CPU 26.

The home network unit 30 is interconnected over a home network with the output device 4, which is an Internet-connectable TV or PC or the like, and an audio device 7. This home network may be a wired LAN such as Ethernet or power-line LAN, or it may be a wireless LAN using wireless communication means employing radio waves such as those specified by the protocols for Bluetooth, HomeRf, IEEE 802.11b or the likes or wireless communication means using infrared rays such as those specified by IrDA. This home network can interconnect air conditioners and refrigerators and other household appliances, and telephones and other communications equipment, and the system can be configured so that the various devices are controlled by the home server 25.

The CPU 26 is interconnected with a wireless communications unit 28 for the transmission of data to and the reception of data from the remote control unit 1 and an address information storage unit 29 for storing acquired URLS.

The CPU 26 acquires over the home network unit 30 state information of the output device 4 or audio device 7, including ON/OFF state, and it can determine whether the various devices are on. For example, in the case of a power-line LAN or a network operating according to IEEE 1394 protocols, the CPU 26 can acquire state information including power state of the output device 4 and the audio device 7 by acquiring the amount of current being consumed by the output device 4 and audio device 7. In the case of an Ethernet, the CPU 26 can acquire state information for a device by constantly sending a packet signal and acquiring LINK ON/OFF signals from the output device 4 and audio device 7.

In such a case, in accordance with the URL it has transmitted from the remote control unit 1, the home server 25 acquires state information of the output device 4 or audio device that is to be operated and sends this state information to the remote control unit 1.

The remote control unit 1 generates control signals for that device based on each device state information it has received, and sends these to the output device 4 along with a selected URL. For example, in cases where it is determined from the received state information that the output device 4 or audio device 7 is off, the remote control unit 1 generates a control signal for an ON instruction. In such a system configuration, control commands for turning the output device 4 and audio device on need to be stored beforehand in the remote control unit 1.

The home server 25 may be configured so that it acquires control commands for turning the output device 4 and audio device on, and stores these in the address information storage unit 29. In such a system configuration, state information of the output device 4 and audio device 7 are acquired, and if this includes the information that the output device 4 or audio device is off, the information processing device 2 reads command controls for turning them on from the address information storage unit 29 and sends these to the remote control unit 1. This eliminates the need to store the control commands for turning on the output device 4 and audio device 7 in the remote control unit 1.

In cases where the home server 25 can control the output device 4 and audio device 7 the system may be configured so that the home server 25 transmits the control commands for turning the output device 4 and audio device 7 on. If it is determined that the output device 4 or audio device 7 to be operated is off, the home server 25 sends to the relevant device the control commands for turning it on, and sends to the remote control unit the URL information list corresponding to the URL.

Operations of the Remote Control Unit

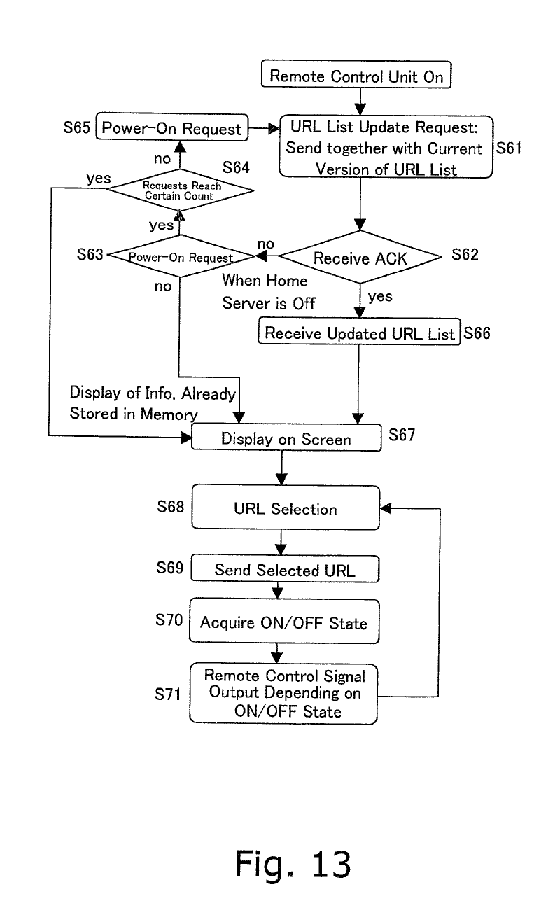

The operations of the remote control unit 1 in the fourth embodiment will be explained with reference made to FIG. 13.

When the remote control unit 1 is turned on, it requests a URL information list update in step S61. Specifically, it sends its current version of the URL information list to the home server 25 and requests that this URL information list be updated.

In step S62, determination is made of whether a signal acknowledging receipt of the update request has been received. If a signal acknowledging receipt of the update request has not been received, control proceeds to step S63. In step S63, determination is made of whether to send a power-on request to the home server 25. If the determination is to make a power-on request to the home server 25 control proceeds to step S64; if the determination is not to make the request, control proceeds to step S67. For example, if the home server 25 is off, the determination is to make a power-on request and control proceeds to step S64. If it is the case that the home server 25 is on but for some reason is unable to send a signal acknowledging receipt of the update request, the determination is made not to make a power-on request to the home server 25, and control proceeds to step S67.

In step S64, determination is made of whether power-on requests have reached a certain count. If it is determined that power-on requests have reached a certain count, then control proceeds to step S67; if it is determined that power-on requests have not reached a certain count, then control proceeds to step S65.

In step S65, a power-on request is sent to the home server 25.

In step S66, the remote control unit 1 receives the URL information list sent by the home server 25. Based on this received URL information list, the remote control unit 1 updates its URL information list.

In step S67, the URL information list is displayed on the address information display unit 11. Specifically, if information has been updated based on the URL information list received from the home server 25, a URL information list based on this updated information is displayed. If the URL information list has not been updated, then a URL information list is displayed on the address information display unit 11 based on the URL information list already stored in its memory 15.

In step S68, the remote control unit 1 accepts selection of a URL. Specifically, the selected URL is specified according to how a user has operated the operation button 13. In step S69, the selected URL is sent to the home server 25.

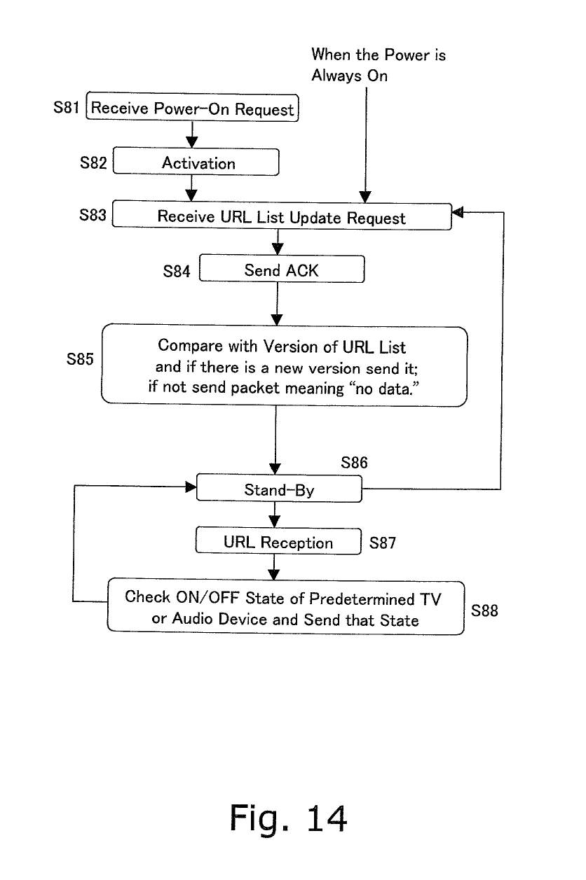

In step S70, state information sent from the home server including the ON/OFF state of the output device 4 or audio device 7 is acquired. In step S71, if the output device 4 or audio device 7 is off, control signal including an ON control command is generated and sent to the output device 4 or audio device 7. Operations of the Home Server The operations of the home server 25 in the fourth embodiment will be explained with reference made to FIG. 14.

If the home server 25 is always on, it is understood that operations commence from step S83. Even if the information processing device 2 is off, it is understood that power is supplied to an interface for receiving power-on requests from the remote control unit 1.

In step S81, when an ON request signal is received from the remote control unit 1, the main power is turned on in step S82 and the home server 25 is activated.

In step S83, an update request for the URL information list sent from the remote control unit 1 is received. In step S84, a signal is sent to the remote control unit 1 acknowledging receipt of the update request signal.

In step S85, the version of the URL information list received from the remote control unit 1 is compared against the version of the URL information list stored in the address information storage unit 29; if there are new versions of URL information, these are sent to the remote control unit 1; if there are no new versions, then a packet indicating “no data” is sent.

In step S86, the home server 25 stands by for reception of a URL information list update request.

In step S87, the URL that a user has selected from among the URLs on the URL information list is received. State information including the ON/OFF state of the output device 4 or audio device 7 is acquired and sent to the remote control unit 1.

Variation

The system can be configured so that based on a URL that a user has selected, determination is made of the type of information corresponding to this URL, and based on this information type control of the output device 4 or audio device is conducted. For example, if the information on a page corresponding to the URL selected by the user is music information, control commands for turning the audio device 7 on and control commands for adjusting volume are issued. Or if the information on a page corresponding to the URL selected by the user is image information, control commands for adjusting the brightness or sharpness of the output device 4 are issued. Control commands for controlling the output device 4 and audio device 7 can be associated with URLs and stored in the address information storage unit 29. When a URL selected by a user has been sent from the remote control unit 1, the home server 25 reads from the address information storage unit 29 the URL information list as well as the control commands corresponding to this URL and sends these to the remote control unit 1. Alternatively, the system may be configured so that the home server 25 reads from the address information storage unit 29 the control commands corresponding to a URL and sends control commands directly to the output device 4 or audio device 7.

Operations of the Remote Control Unit

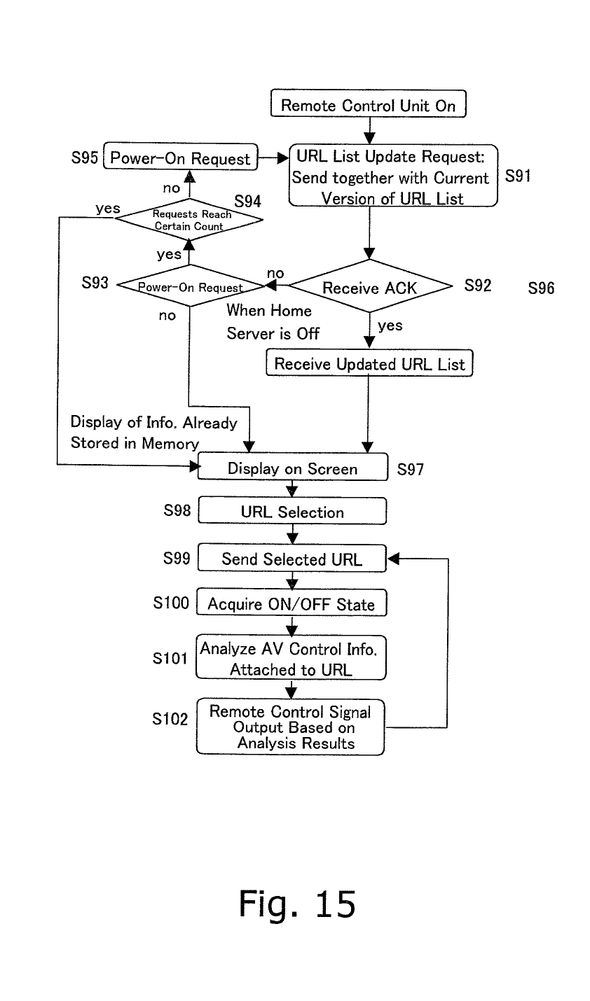

The operations of the remote control unit 1 in such a configuration will be explained with reference made to FIG. 15.

When the remote control unit 1 is turned on, in step S91 it requests update of the URL information list. Specifically, it sends its version of the URL information list to the home server 25 and requests that it be updated.

In step S92, determination is made of whether a signal from the home server 25 acknowledging receipt of the update request has been received. If it is determined that a signal acknowledging receipt of the update request has not been made, control proceeds to step S93. In step S93, determination is made of whether to make a power-on request to the home server 25. If determination is made to make a power-on request to the home server 25, control proceeds to step S94; if determination is made not to make a power-on request to the home server 25, control proceeds to step S95. For example, if the home server 25 is off, then a power-on request is to be made and control proceeds to step S94. If the home server 25, even though it is on, is for some reason unable to acknowledge that is has received an update request, determination is made not to make a power-on request to the home server 25 and control proceeds to step S97.

In step S94, it is determined whether power-on requests have reached a certain count. If it is determined that the power-on requests have reached a preset count, control proceeds to step S97; if it is determined that the power-on requests have not reached a preset count, control proceeds to step S95.

In step S95, a power-on request is sent to the home server 25.

In step S96, the URL information list sent from the home server 25 is received, based upon which the remote control unit updates its URL information list.

In step S97, the URL information list is displayed on the address information display unit 11. Specifically, if information has been updated based on the URL information list received from the home server 25, then the display of the URL information list is conducted according to such updated information. If the URL information list has not been updated, the URL information list is displayed on the address information display unit 11 according to the URL information list already stored in its memory 15.

In step S98, the remote control unit 1 accepts selection of a URL. Specifically, the selected URL is specified according to how the user operated the operation button 13. In step S99, the selected URL is sent to the home server 25.

In step S100, state information including the ON/OFF state of the output device 4 or audio device 7 is sent from then home server 25. At this time, control information to the output device and audio device 7 attached to the URL is also received.

In step S101, the received control information for the output device 4 or audio device 7 is analyzed. As described above, the remote control unit 1 acquires control information attached to the URL, so that, if the page is of music information, the remote control unit 1 issues command controls for turning on the audio device 7 and command controls for adjusting volume; if the page is of image information, the remote control unit 1 issues control commands for adjusting the brightness of the screen or control commands for adjusting sharpness. In step S102, control signals based on the results of the analysis are generated and sent to the output device 4 or audio device 7. Specifically, the system can be configured so that, based on the analyzed control information, control commands are issued to the output device or audio device 7.

The operations of the home server 25 in such a system configuration is the same as the operations described in the flowchart of FIG. 14, and a detailed explanation will be omitted here.

Fifth Embodiment

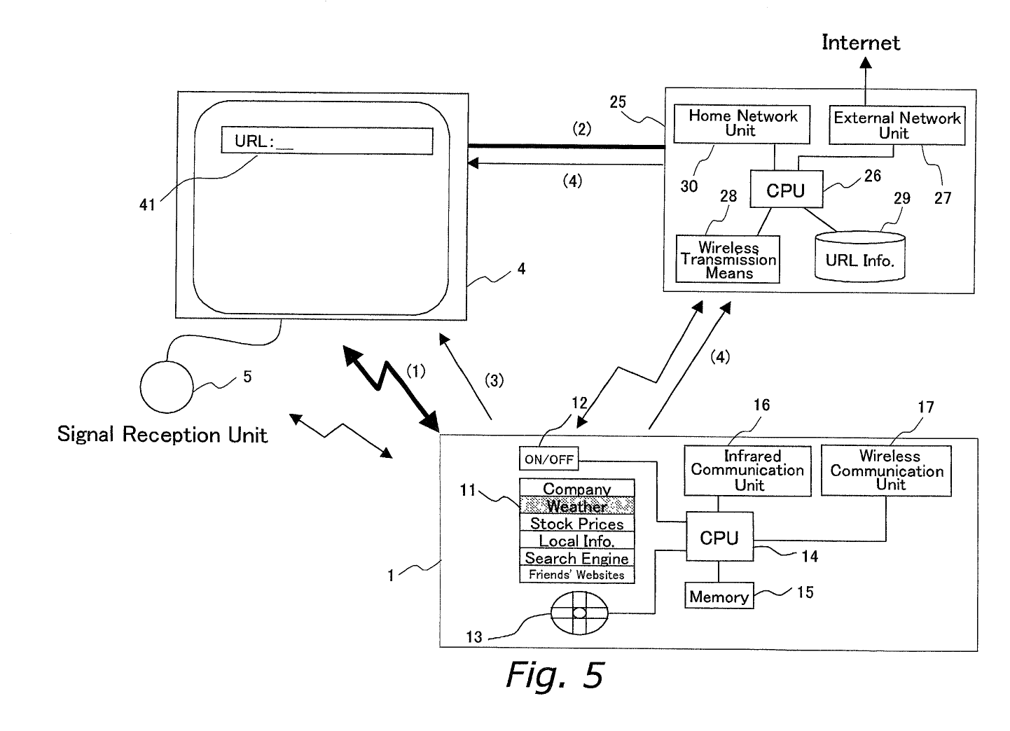

A device control system according to a fifth embodiment of the present invention will be explained with reference made to FIG. 5.

In this fifth embodiment we shall consider a case where control commands for the output device 4 can be externally extracted and used.

The output device 4 contains built-in commands such as those exemplified by the AV/C commands for the IEEE 1394 bus standards for ON/OFF, image playback, volume adjustment, picture adjustment and the like, and these control commands can be externally extracted. In such a case, a system configuration is possible so that data is transmitted and received via infrared rays between the remote control unit 1 and the output device 4, and the control commands are read directly by the remote control unit 1. Alternatively, the system may be configured so that the control commands for the output device 4 are extracted by the home server 25, which is interconnected with the output device over a home network.

The home server 25 can be configured so that it is interconnected via the home network unit 30 with the various devices, and so that it stores in the address information storage unit 29 control commands extracted from the output device 4.

The remote control unit 1 may be configured so that control commands of the output device 4 and specific manipulations of the operation button 13 can be correlatively registered. For example, the system may be configured so that by correlating a specific way of manipulating the operation button 13 with the ON control command for the output device 4, the remote control unit 1 sends an ON instruction to the output device 4. The system may be configured so that command controls for the output device are allotted to a portion of the address information display unit 11, and when a control command has been selected from the operation button 13, it is issued to the output device 4.

The system may be configured so that when a control command is directly extracted by the remote control unit 1, control commands can be issued directly from the remote control unit 1 to the output device 4. Alternatively, the system may be configured so that when a control command is extracted by the home server 25, using data sent based on a specific manipulation of the remote control unit 1, control commands are issued by the home server 25, and the output device 4 is controlled over the home network.

With such a system configuration, the remote control unit can be taught the control commands for the output device 4, and even if it does not have built-in control commands of the output device 4 beforehand, the remote control unit 1 can issue control commands, and a single remote control unit can consolidate the administration of a plurality of devices.

Operations of the Home Server

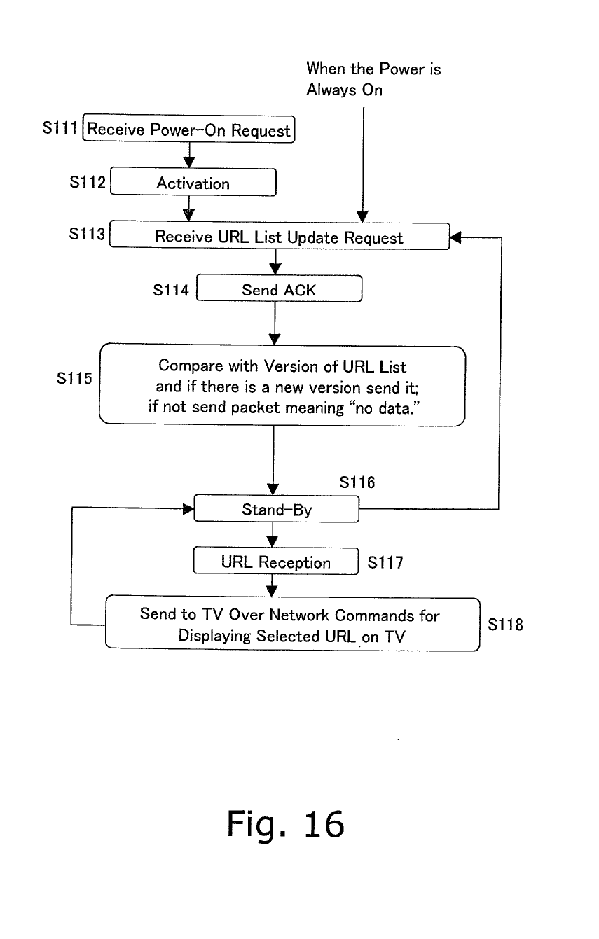

FIG. 16 will be used to explain operations of the home server 25 in a case where it has extracted control commands of the output device 4 and store these in the address information storage unit 29.

If the home server 25 is always on, it is understood that operations commence from step S113. Even if the home server 25 is off, it is understood that power is supplied to an interface for receiving power-on requests from the remote control unit 1.

In step S111, when a power-on request is received from the remote control unit 1, in step S112, the main power is turned on, and the home server 25 is activated.

In step S113, the home server 25 receives a signal from the remote control unit 1 requesting URL information list update. In step S114, the home server 25 sends a signal acknowledging receipt of the update request to the remote control unit 1.

In step S115, the URL information list version sent from the remote control unit 1 is compared with the URL information list version stored in the address information storage unit 29; if there are new versions of URLs, these are sent to the remote control unit 1; if there is no new version, a packet indicating “no data” is sent.

In step S116, the home server 25 stands by for receipt of a URL information list update request.

In step S117, the URL selected by a user from among the URLs on the URL information list is received. In step S118, control commands are issued for displaying on the output device 4 the information corresponding to that received URL, and these control commands are sent to the output device 4 over the home network.

Specifically, the control commands extracted in advance from the output device 4 are stored in the address information storage unit 3 and these command operations and specific operations of the remote control unit 1 are correlatively and registered. When a signal has arrived through a predetermined manipulation of the remote control unit 1, through the issue of control commands stored in the address information storage unit 29, the output device 4 can be controlled.

It should be noted that the operations of the remote control unit 1 are essentially the same as those described by the flowchart in FIG. 9 of the first embodiment, with the only difference being that in place of the “remote control signal output” of step S19, is “sending URL to the home server 25.”

Sixth Embodiment

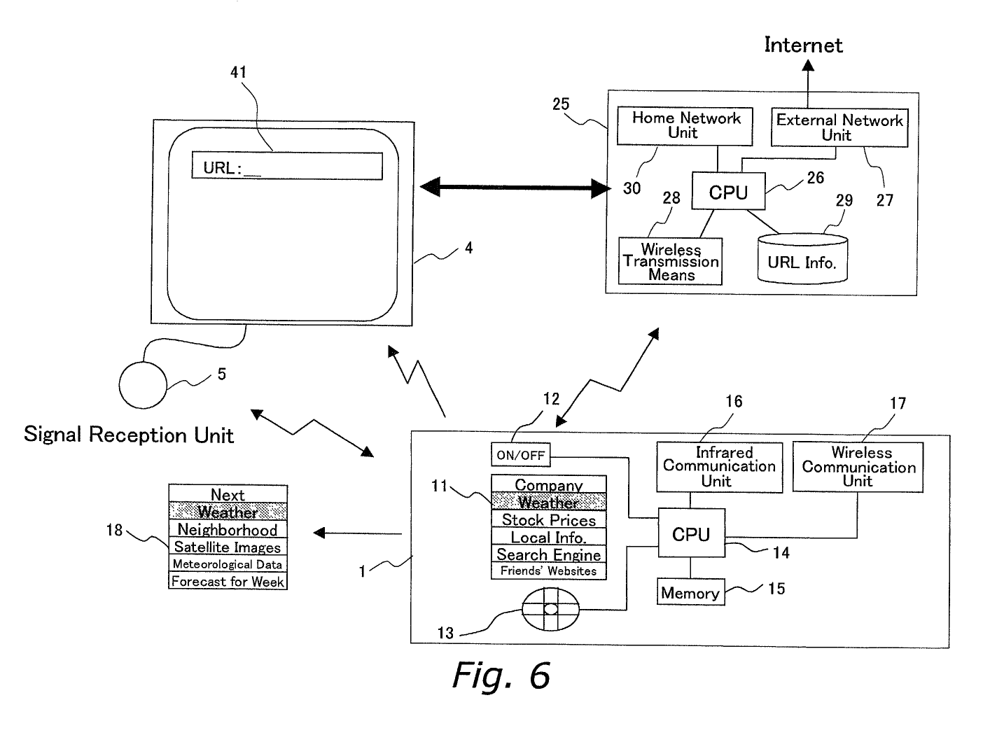

A device control system according to a sixth embodiment of the present invention will be explained with reference made to FIG. 6.

For this sixth embodiment, we shall consider a case where the output device 4 acquires information over the Internet via the home server 25.

When the operation button 13 has been manipulated and a URL has been selected, a URL information list is sent from the home server 25 to the remote control unit 1, and the URL information list in the remote control unit 1 is updated. The URL selected at the remote control unit 1 is sent to the output device 4.

The output device 4 sends over the Internet via the home server 25 a request for the information corresponding to the URL sent from the remote control unit 1, and then receives the relevant information and displays this on the screen. The home server 25 serves as a proxy for the information request packets from the output device 4 and information packets from the Internet addressed to the output device 4; of these packets, it fetches information packets addressed to the output device 4, and fetches the URLs contained in those packets. These URLs are stored in address information storage unit 29 in a state that includes link information and the like.

With such a system configuration, the URL for information requested at the output device 4 can be acquired by the home server 25, and URLs can be collected as requested by a user. The operations of the remote control unit 1 in this sixth embodiment are the same as the operations of the remote control unit 1 in the third embodiment, as seen in the flowchart of FIG. 11. The operations of the home server 25 are the same as the operations of the information processing device 2 in the third embodiment, as seen in the flowchart of FIG. 12.

Seventh Embodiment

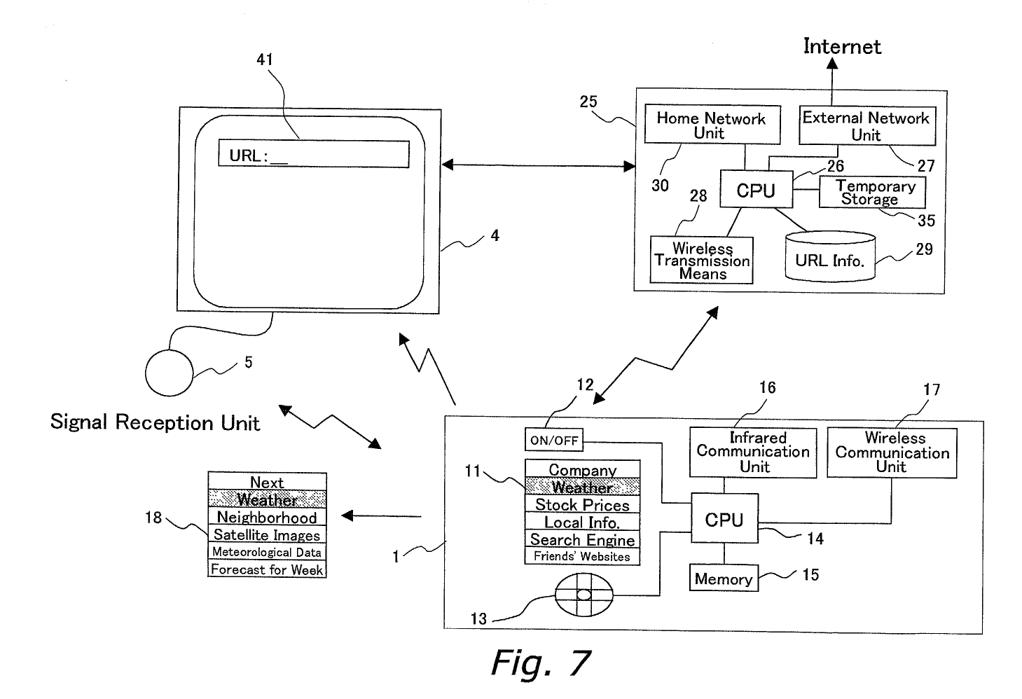

FIG. 7 shows a device control system according to a seventh embodiment of the present invention.

For this seventh embodiment, we shall consider a case where the home server 25 includes a temporary storage means 35 for the temporary storage of URLs.

The temporary storage means 35 provided in the home server can be a cache such as cache memory or disk cache; it temporarily stores as historical information the URLs for information that has been displayed at the output device 4. The capacity of the temporary storage means 35 is limited, so it can be configured to delete stored URLs starting with the oldest, in accordance with predetermined conditions, such as over capacity or elapse of time.

The remote control unit 1 is provided with a list addition button 19. This list addition button 19 gives instructions to add the URL for the information currently being display on the output device 4 to the URL information list.

When the list addition button 19 of the remote control unit is operated, list addition instruction signals are sent to the home server 25. Based on this signal, the home server 25 extracts the relevant URL stored in the temporary storage means 35 and updates the URL information list stored in the address information storage unit 29.

With such a system configuration, a user can immediately add the URL for the information currently being displayed to the URL information list, and the URL information list can be updated with a simple operation.

Operations of the Remote Control Unit

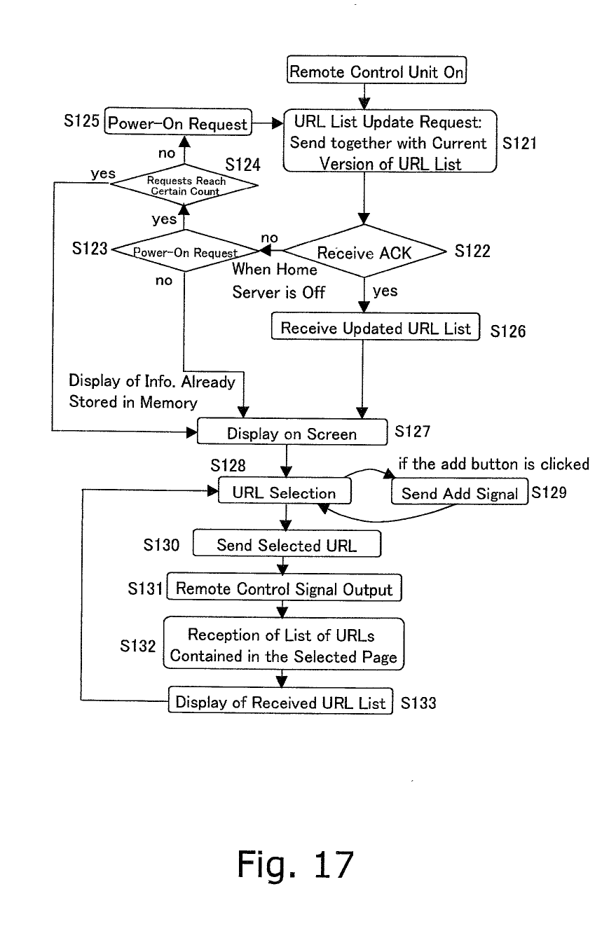

The operations of the remote control unit 1 according to the seventh embodiment will be explained with reference made to FIG. 17.

When the remote control unit 1 is turned on, in step S121 it requests update of the URL information list. Specifically, it sends its current version of the URL list information and requests that this URL information list be updated.

In step S122, determination is made of whether there has been receipt of a signal from the home server 25 acknowledging receipt of the update request. If a signal acknowledging receipt of update request has not been received, control proceeds to step S123. In step S123, determination is made of whether to send a power-on request to the home server 25. If determination is made to send a power-on request to the home server 25, control proceeds to step S124; if not, control proceeds to step S127. For example, if the home server 25 is off, determination is made to send a power-on request to the home server 25, and control proceeds to step S124. If for some reason the home server 25, even though it is on, is unable to send a signal acknowledging receipt of the update request, determination is made not to send a power-on request to the home server 25, and control proceeds to step S127.

In step S124, determination is made of whether power-on requests have reached a certain count. If it is determined that the power-on requests have reached a preset count, control proceeds to step S127; if it is determined that the power-on requests have not reached a preset count, control proceeds to step S125.

In step S125, the remote control unit 1 transmits a power-on request to the home server 25.

In step S126, the remote control unit 1 receives the URL information list sent from the home server 25, based upon which it updates its URL information list.

In step S127, the URL information list is displayed on the address information display unit 11. Specifically, if information has been updated based on the URL information list received from the home server 25, then the URL information list is displayed in accordance with such updated information. If the URL information list has not been updated, a URL information list is displayed on the address information display unit 11 according to the URL information list already stored in its memory.

In step S128, selection of a URL is accepted. Specifically, the selected URL is specified according to how a user operated the operation button 13. If the list addition button 19 has been operated, control proceeds to step S129. In step S129, signals instructing list addition are sent to the home server 25, which is instructed to add to the URL information list the URL of the information currently displayed on the output device 4. After signals instructing addition to list are sent, control proceeds to step S128.

In step s130 the selected URL is sent to the home server 25. In step S131, control signals for the output device 4 are generated based on the selected URL, and these control signals are sent to the output device 4.

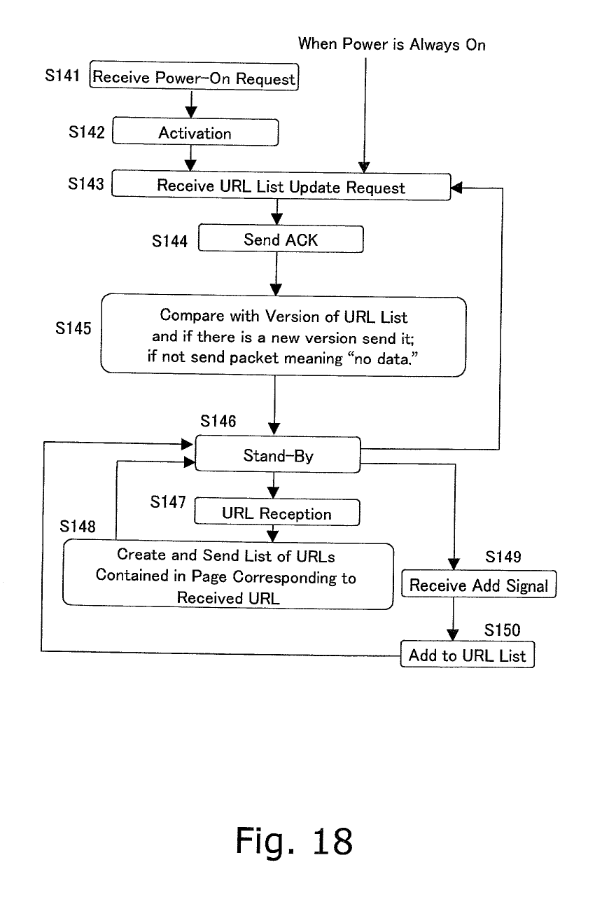

In step S132 the URL information list corresponding to the selected URL is received from the home server 25. In step S133, the received URL information list is displayed on the address information display unit 11 as a sub-list. Thereafter control proceeds to step S128, and accepts further selection of URLs. Operations of the Home Server The home server 25 according to the seventh embodiment will be explained with reference made to FIG. 18.

If the home server 25 is always on, it is understood that operations commence from step S143. Even if the home server 25 is off, it is understood that power is supplied to an interface for receiving power-on requests from the remote control unit 1.

In step S141, when an ON request signal is received from the remote control unit 1, the main power is turned on in step S142, and the home server 25 is activated.

In step S143, an update request for the URL information list sent from the remote control unit 1 is received. In step S144, a signal is sent to the remote control unit 1 acknowledging receipt of the update request signal.

In step S145, the version of the URL information list received from the remote control unit 1 is compared against the version of the URL information list stored in the address information storage unit 29; if there are new versions of URLs, these are sent to the remote control unit 1; if there are no new versions, then a packet indicating “no data” is sent.

In step S146, the home server 25 stands by for reception of a URL information list update request, reception of a URL included on the URL information list, or reception of a signal indicating addition of a URL.

In step S147, the URL that a user has selected from among the URLs on the URL information list is received. In step S148, a list of URLs included in the information corresponding to the received URL is created and sent to the remote control unit 1. For example, in such cases as when link information is contained in a page corresponding to the URL received from the remote control unit 1, a list of the URLs corresponding to this link information is created and sent to the remote control unit 1. Thereafter control returns to step S146.

In step S149, a signal instructing addition to the list is received from the remote control unit 1. In step S150, the URL of the information currently being displayed on the output device 4 is added to the URL information list, and the URL information list stored in the address information storage unit is updated. Thereafter, control returns to step S146.

Eighth Embodiment

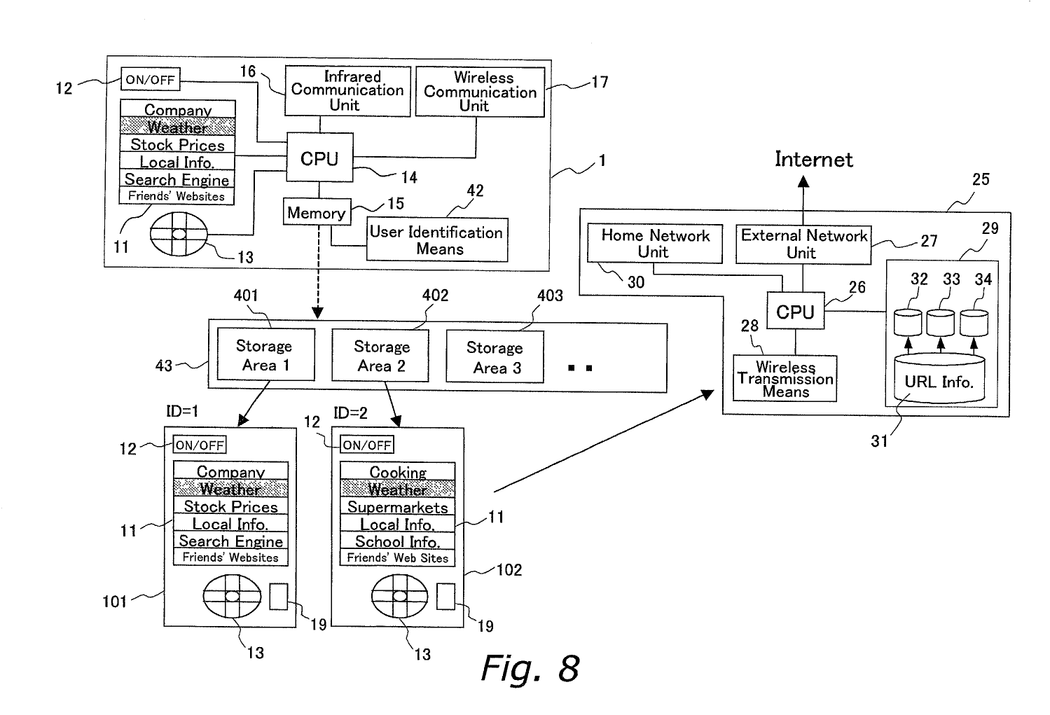

FIG. 8 shows a device control system according to an eighth embodiment of the present invention.

For this eighth embodiment we shall consider a case where a remote control unit used by a plurality of users is adapted for use by each user.

The remote control unit 1 contains user identification means 42 and individual information storage means 43. The user identification means 42 conducts authentication of a user who is using the remote control unit 1; for example, by comparing a password stored in the individual information storage means with an inputted password it authenticates whether the inputter of that password is a user registered in the individual information storage means 43. This user identification means 42 may also use biological information, such as fingerprint information, iris information, retinal information, voice information and the like; in such cases additional hardware would be needed, such as image processing means or voice processing means.

The individual information storage means 43 may be configured so that it records personal information in a portion of the memory 15; prepared therein are a first record area 401, a second record area 402, a third record area 403, and so on. Stored within each record area are data for authentication of that specific user, that user's URL information list, and so on.

When a user has been authenticated by the user identification means 42, the URL information list for that user is displayed at the address information display unit 11. For example, the remote control unit 1 can be configured so that for user with ID #1, it functions as an operating terminal 101; for user with ID #2, it functions as an operating terminal 102.

The system can be configured so that the address information storage unit 29 of the home server 25 creates individual list files 32, 33, 34, and so on to correspond to each user URL information list. These individual list files 32, 33, 34, and so on store the URLs for each user that have been picked out from a master file 31 of the address information storage unit 29; they can be stored as virtually independent files within the address information storage unit 29, or they may be configured as physically independent files.

When the remote control unit 1 has been manipulated and a specific URL has been selected, identification information for the current user as well as the selected URL is sent to the home server 25. The home server 25 selects the individual list file that corresponds to the received user identification information, and sends the most recent URL information list to the remote control unit 1. The system can be configured so that when a URL information list is updated in accordance with a user's operations, the individual list file for that user is updated.

With such a system configuration, a plurality of users can use URL information lists they have designed according to their preferences, making operations at the time of information output to the output device 4 easier.

Operations of the Remote Control Unit

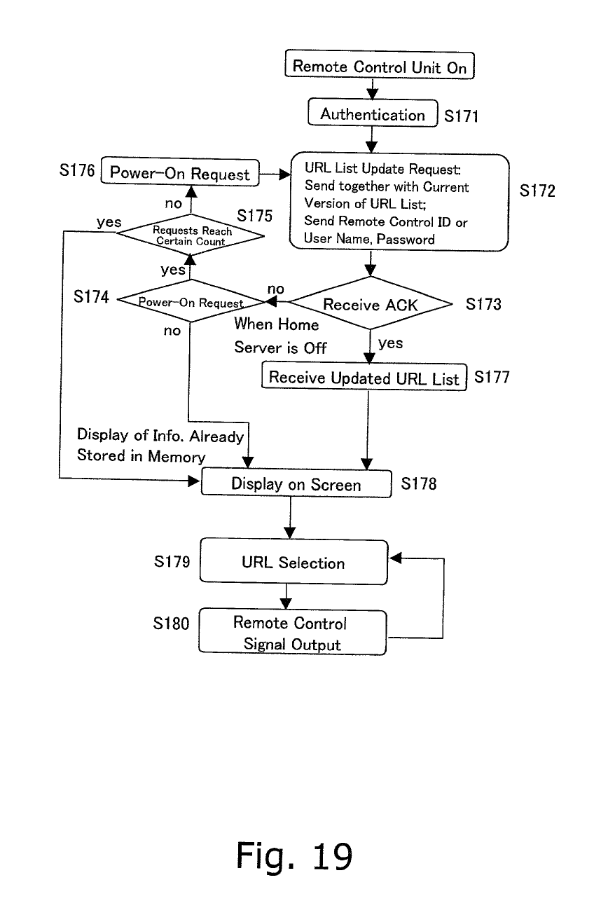

The operations of the remote control unit 1 in accordance with the eighth embodiment will be explained with reference made to FIG. 19.

When the remote control unit 1 is turned on, in step S171 it conducts user authentication. Specifically, a user-inputted password or biological information is compared with data stored in the individual information storage means 43 and authentication is made as to whether the inputter is a properly registered user. If authentication fails, an error message is displayed and processing ends. If authentication is successful, then control proceeds to step S172.

In step S172, a URL information list update is requested. Specifically, the remote control unit 1 sends its current version of the URL information list, ID information for the remote control unit 1, user name, password and other required personal information to the home server 25, and requests update of the URL information list.

In step S173, determination is made of whether a signal from the home server 25 acknowledging receipt of the update request has been received. If a signal acknowledging receipt of update request has not been received, control proceeds to step S174. In step S174, determination is made of whether to send a power-on request to the home server 25. If determination is made to send a power-on request to the home server 25, control proceeds to step S175; if not, control proceeds to step S178. For example, if the home server 25 is off, determination is made to send a power-on request to the home server 25, and control proceeds to step S175. If for some reason the home server 25, even though it is on, is unable to send a signal acknowledging receipt of the update request, determination is made not to send a power-on request to the home server 25, and control proceeds to step S178.

In step S175, determination is made of whether power-on requests have reached a certain count. If it is determined that power-on requests have reached a preset count, control proceeds to step S178; if it is determined that power-on requests have not reached a preset count, control proceeds to step S176.

In step S176, a power-on request is sent to the home server 25.

In step S177, the URL information list sent from the home server 25 is received. The received URL information list is information stored in the individual list files managed for each user; based on this received URL information list, the URL information list in the individual information storage means 43 is updated.

In step S178, the URL information list is displayed at the address information display unit 11. Specifically, when information has been updated based on the URL information list received from the home server 25, the URL information list is displayed in accordance with that updated information. If the URL information list has not been updated, then the remote control unit 1 displays a URL information list in accordance with the URL information list already stored in its memory 15.

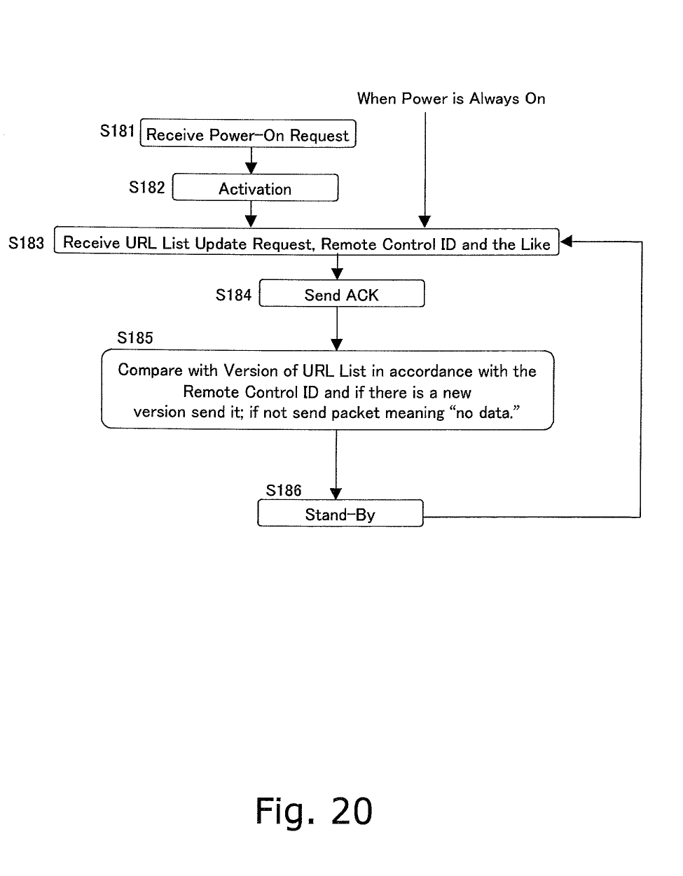

In step S179, selection of a URL is accepted. Specifically, the selected URL is specified according to how a user operated the operations button 13. In step S180, control signals for the output device 4 are generated based on the selected URL, and these control signals are sent to the output device 4. Operations of the Home Server The operations of the home server 25 according to the eighth embodiment will be explained with reference made to FIG. 20.

If the home server 25 is always on, it is understood that operations commence from step S183. Even if the home server 25 is off, it is understood that power is supplied to an interface for receiving power-on requests from the remote control unit 1.

In step S181, when an ON request signal is received from the remote control unit 1, the main power is turned on in step S182 and the home server 25 is activated.

In step S183, an update request for the URL information list sent from the remote control unit 1 is received. The home server also receives the ID number of the remote control unit 1 and personal information such as user name and password, which are sent at the same time. In step S184, a signal is sent to the remote control unit 1 acknowledging receipt of the update request signal.

In step S185, the version of the URL information list received from the remote control unit 1 is compared against the version of the URL information list stored in the individual list file corresponding to the ID number of the remote control unit or user name included in the URL information; if there are new versions of URLs, these are sent to the remote control unit 1; if there is no new version, then a packet indicating “no data” is sent.

In step S186, the home server 25 stands by for reception of a URL information list update request.

Other Embodiments

The system can be configured so that by making the address information storage unit 24 or address information storage unit recording means for recording image information, image information such as TV programs can be stored, simplifying the recording and playback of programs.

Adoption of the present invention allows the simple input of an address indicating where information is stored , the input to be made at an operating terminal that controls an output device, and facilitates the control of an output device.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A device control system for acquiring information from a storage location indicated by address information and controlling an output device that is to output said information, comprising:
address information acquisition means for acquiring address information corresponding to information that can be outputted by said output device;
address information list administration means for storing one or a plurality of address information needed by a user as an address information list, and for updating said address information list based on address information acquired by said address information acquisition means;
address information display means for displaying the address information included on said address information list;
input acceptance means for allowing selection of address information to be outputted to said output device, said selection to be made from among the address information displayed by said address information display means; and
device control means for sending control signals to said output device based on the address information accepted by said input acceptance means.

2. The device control system according to claim 1, further comprising address information storage means for storing address information acquired by said address information acquisition means.

3. The device control system according to claim 1, wherein said address information list administration means, based on address information accepted by said input acceptance means, updates the address information list relating to this address information.

4. The device control system according to claim 1, further comprising state information acquisition means for acquiring state information for said output device, and wherein:
said device control means generates control signals based on said state information of said output device and sends these signals to said output device.

5. The device control system according to claim 1, further comprising:
control command acquisition means for acquiring control commands for said output device, and
control command learning means for linking control commands acquired by said control command acquisition means with said input acceptance means and storing the same.

6. The device control system according to claim 1, further comprising information type determination means for determining the type of information that corresponds to the address information accepted by said input acceptance means, and wherein:
said device control means generates control signals for said output device based upon the results of the determination of said information type determination means.

7. The device control system according to claim 1, wherein said address information list administration means manages address information corresponding to a plurality of users, and said address information display means selects from the address information list managed by said address information list administration means an address information list corresponding to a user, and displays the same.

8. The device control system according to claim 7 further comprising user identification means for identifying each user corresponding to the address information lists managed by said address information list administration means.

9. An operating terminal for acquiring information from a storage location indicated by address information, and for sending control signals to the output device that is to output said information, comprising:
address information list administration means for storing one or a plurality of address information required by a user as an address information list;
address information display means for displaying address information included on said address information list;
input acceptance means for allowing the selection of address information for information to be outputted at said output device, said selection to be made from among the address information displayed by said address information display means; and
device control means for sending control signals to said output device based on address information accepted by said input acceptance means.

10. The operating terminal according to claim 9, further comprising data transmission and reception means for the wired or wireless transmission and reception of data with an information processing device having address information acquisition means for acquiring address information corresponding to information capable of being outputted to said output device, and wherein address information acquired by said address information acquisition means of said information processing device is acquired by means of said data transmission and reception means, and the address information list managed by said address information list administration means is updated.

11. The operating terminal according to claim 10, wherein based on address information accepted by said input acceptance means, said address information list administration means acquires from said information processing device address information relating to this address information and updates said address information list.

12. The operating terminal according to claim 9, further comprising state information acquisition means for acquiring state information of said output device, and wherein:
said device control means generates control signals based on state information of said output device and sends these to said output device.

13. The operating terminal according to claim 9, further comprising:
control command acquisition means for acquiring control commands for said output device, and control command learning means for linking control commands acquired by said control command acquisition means with said input acceptance means and storing the same.

14. The operating terminal according to claim 9, further comprising information type determination means for determining the type of information that corresponds to the address information accepted by said input acceptance means, and wherein:
said device control means generates control signals for said output device based upon the results of the determination of said information type determination means.

15. The operating terminal according to claim 9, wherein said address information list administration means manages address information corresponding to a plurality of users, and said address information display means selects from the address information list managed by said address information list administration means an address information list corresponding to a user, and displays the same.

16. The operating terminal according to claim 15, further comprising user identification means for identifying each user corresponding to the address information lists managed by said address information list administration means.

17. An information processing device able to acquire information from a storage location indicated by address information and to send data to and receive data from an operating terminal that sends control signals to an output device that is to output said information, comprising:
address information acquisition means for acquiring address information corresponding to information that can be outputted by said output terminal, and
address information list sending means for sending the address information needed by a user from among the address information acquired by said address information acquisition means in accordance with requests from said operating terminal.

18. The information processing device according to claim 17, further comprising communications means capable of connecting with the Internet.

19. The information processing device according to claim 17, further comprising address information storage means for storing address information acquired by said address information acquisition means.

20. The information processing device according to claim 17, further comprising state information acquisition means for acquiring state information of said output device, and wherein said state information is sent in accordance with requests from said operating terminal.

21. The information processing device according to claim 17, further comprising control command acquisition means for acquiring control commands for said output device, and wherein said control commands are sent in accordance with requests from said operating terminal.

22. The information processing device according to claim 19, wherein control commands for said output device are preset based on the type of information that corresponds to said address information and stored in said address information storage means, and in accordance with requests from said operating terminal, said address information is sent together with the corresponding control commands.

23. The information processing device according to claim 17, said information processing terminal being a home server interconnected in a wired or wireless manner with said output device.

24. The information processing device according to claim 23, wherein said address information acquisition means extracts and acquires address information contained in packets sent by said output device to request information.

25. The information processing device according to claim 23, further comprising state information acquisition means for acquiring state information for said output device, and wherein said state information is sent in accordance with requests from said operating terminal.
